(19) United States
(12) Patent Application Publication
(10) Pub. No.: US 2012/0092782 A1
(43) Pub. Date: Apr. 19, 2012

(54) Split Spherical Mirror Configuration for Optical Multipass Cell

(76) Inventors: Stephen So, Fairless Hills, PA (US); David Thomazy, Highland Park, NJ (US)

(21) Appl. No.: 13/273,261

(22) Filed: Oct. 14, 2011

Related U.S. Application Data
(60) Provisional application No. 61/394,056, filed on Oct. 18, 2010.

(51) Int. Cl. G02B 17/00

(52) U.S. Cl. 359/858

(57) ABSTRACT

An optical multipass cell (MPC) configuration is presented that utilizes pairs of split spherical mirrors to provide a beam pattern density on the order of a pure astigmatic arrangement without the need to utilize specially-ground and aligned astigmatic mirrors. Relatively inexpensive spherical mirrors are “split” into at least pairs, and tilted inward along the optical axis. Each mirror half may be tilted at a common angle or, alternatively, each mirror half may be positioned at a unique tilt angle. The spot pattern density is on the order of a pure astigmatic cell, but at a significantly reduced cost.

### CROSS REFERENCE TO RELATED APPLICATIONS

This application claims the benefit of U.S. Provisional Application No. 61/394,056, filed Oct. 18, 2010 and herein incorporated by reference.

### TECHNICAL FIELD

The present invention relates to an optical multipass cell (MPC) configuration and, more particularly, to an arrangement that utilizes pairs of split spherical mirrors to provide a beam pattern density on the order of a pure astigmatic arrangement without the need to utilize specially-ground and aligned astigmatic mirrors.

### BACKGROUND OF THE INVENTION

Multipass cells (MPCs) shoot a laser beam into an optical cavity and bounce the beam off of mirrors multiple times in a defined spot pattern. These multipass cells are used in a variety of applications including laser resonators through a gain medium, long optical paths for trace-gas sensing via laser spectroscopy, macro optical delay lines, and many others.

There are various multipass cell configurations known in the prior art which do not overlap spots in a dense pattern. These configurations generally take the form of either pure astigmatic cells or cylindrical mirror-based multipass cells. The mirrors for pure astigmatic cells must be machined to extremely high tolerances for matching purposes (thereby increasing overall system cost), since mismatched mirrors require rotation of one of the mirrors to provide a “reentrant condition” for maximum stability. The astigmatic cell was first described in the article “Off-axis paths in spherical mirror interferometers” by D. Herriott et al. appearing in Applied Optics, Vol. 3, 523 et seq., 1964. A significant problem with the use of the astigmatic configuration is the high cost of extreme-precision tolerance mirrors with exact focal lengths to achieve a stable reentrant pattern. An alternative to the precision tolerance ground mirrors is to use a spherical mirror with compressing stress along one axis to bend the mirror and achieve an astigmatic mirror. Improvements to the alignment of such cells using relaxed tolerance ground astigmatic mirrors have been developed by Aerodyne Research, Inc., as disclosed in U.S. Pat. No. 5,291,265 issued to P. L. Kebabian on Mar. 1, 1994, which utilizes a pair of mirrors that are fabricated so that the ratios of their radii of curvature are actually larger than the values calculated from simulations. This improvement allowed for the rotation on the axis of the mirrors to allow for the use of such lower tolerance mirrors.

The cylindrical mirror-based cells provide the same astigmatic configuration of spots and are lower cost. However, the cylindrical patterns do not refocus the beam in both vertical and horizontal directions for each bounce at the mirrors and, therefore, do not achieve the pattern density required for advanced applications. A recent type of astigmatic cell using cylindrical mirrors is described in U.S. Pat. No. 7,307,716 entitled “Near Re-Entrant Dense Pattern Optical Multipass Cell” and issued to J. A. Silver on Dec. 11, 2007. Cylindrical mirrors are typically ground with a poorer precision surface quality (λ), which can cause scattering of the optical beam, leading to increased fringing compared to off-the-shelf spherical mirrors which are ground at better than λ/4.

Another type of cell is the White cell, described in the article “Long Optical Paths of Large Aperture” by J. U. White et al., appearing in the Journal of the Optical Society of America, No. 32 (1942), pp. 285-288. This type of cell overlaps passes and also requires the use of a three mirror configuration. Overlapped passes are undesired in many applications due to interference fringe effects. These types of cells are frequently sold as add-ons to FTIR based spectrometers.

One of the newer types of multipass cell is a spherical mirror-split spherical minor cell, as described in the article “Simple, stable and compact multiple-reflection optical cell for very long optical paths” by C. Robert and appearing in Applied Optics, Vol. 46, No. 22, August 2007, pp. 5408 et seq. This type of cell causes the spot pattern to spiral into the center and also presents some beam quality issues, since the spot pattern does not “see” symmetric surfaces.

Thus, a need remains in the art for an optical multipass cell configuration that provides the desired spot pattern density achievable with the pure astigmatic cell, but without incurring the high costs associated with the fabrication of such extreme-precision components.

### SUMMARY OF THE INVENTION

The need remaining in the art is addressed by the present invention, which relates to an optical multipass cell (MPC) configuration and, more particularly, to an arrangement that utilizes pairs of split spherical mirrors to provide a beam pattern density on the order of a pure astigmatic arrangement without the need to utilize specially-ground and aligned astigmatic mirrors.

A new type of multipass cell has been developed in accordance with the present invention that utilizes a pair of split-spherical mirrors that are tilted along the same axis as the mirror cut. Each mirror half may be tilted at a common angle or, alternatively, each mirror half may be positioned at a unique tilt angle.

The spot pattern of the novel multipass cell resembles multipass cells that provide astigmatic patterns (Lissajous patterns), but advantageously uses easy to manufacture, low cost, spherical mirrors instead of astigmatic or cylindrical mirrors.

Additionally, the present invention discloses a method to manufacture the required geometry of mirrors at low cost. A pair of slabs are first joined together with a removable adhesive material (or held in place with a clamping arrangement) and processed as a single unit to form a spherical mirror. The slabs are then released, with each individual slab then taking the form of a half of the spherical surface.

This invention also describes various angled mirror mounting methods. The development allows low total cost for the cell, allowing commercially feasible development of multipass sensors using additional sensor methodologies, including dual astigmatic-pattern cell balanced detection, astigmatic-pattern multipass photoacoustic spectroscopy, and astigmatic-pattern multipass Faraday rotation spectroscopy.

Various and other advantages and aspects of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 illustrates a side view of an exemplary optical multipass cell using tilted split spherical mirrors in accordance with the present invention;

FIG. 2 is an isometric view of the arrangement of FIG. 1, including ray tracing of an exemplary beam pattern;

FIGS. 3(a) and (b) illustrate exemplary prior art beam spot patterns (FIG. 3(a) for a “left hand” mirror and FIG. 3(b) for “right hand” mirror);

FIGS. 4(a) and (b) illustrate simulated spot patterns for a configuration of the present invention, FIG. 4(a) for the “left hand” split mirror pair and FIG. 4(b) for the “right hand” split mirror pair;

FIGS. 5(a) and (b) illustrate simulated spot patterns for a different configuration of the present invention, FIG. 5(a) for the “left hand” split mirror pair and FIG. 5(b) for the “right hand” split mirror pair;

FIGS. 6(a) and (b) illustrate simulated spot patterns for yet another configuration of the present invention, FIG. 6(a) for the “left hand” split mirror pair and FIG. 6(b) for the “right hand” split mirror pair; and

FIG. 7 illustrates an exemplary fabrication process sequence for forming a split pair of spherical mirror halves in accordance with the present invention.

### DETAILED DESCRIPTION

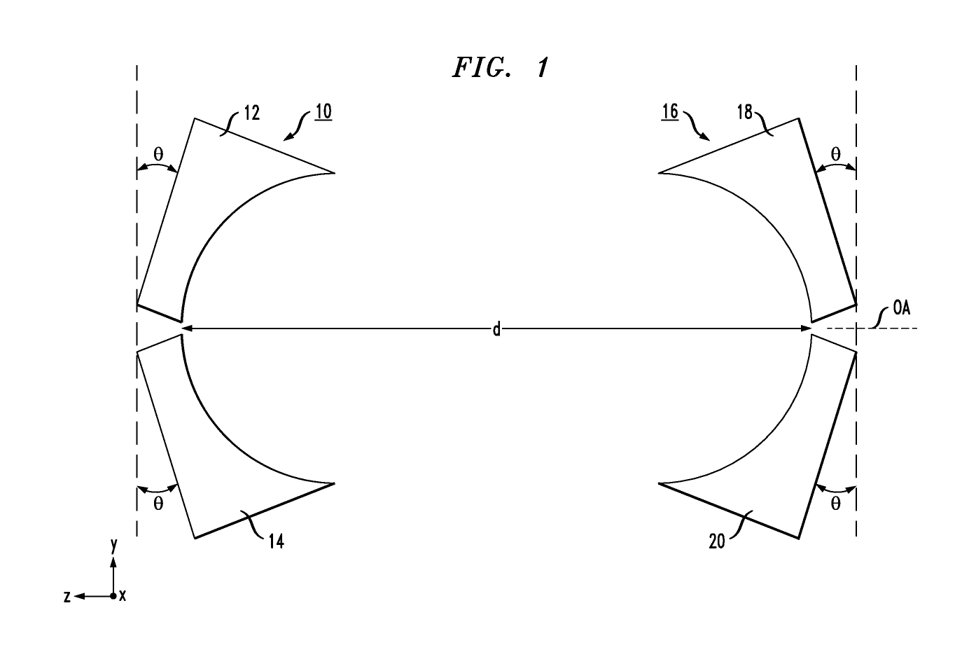

FIG. 1 illustrates an exemplary “split-spherical” mirror pair used to form an optical multipass cell in accordance with the present invention. This provides a similar spot pattern to the astigmatic cell, with the possibility for no beam overlap. The beam spot pattern can be simulated using ABCD matrix ray tracing analysis, with an adjustment for off-axis mirrors. The complex beam parameter can be used along with the ABCD matrices to estimate beam spreading and refocusing to determine spot sizes on the mirrors. Using these simulations, a pattern can be found which closely resembles a Lissajous pattern characteristic of astigmatic cells.

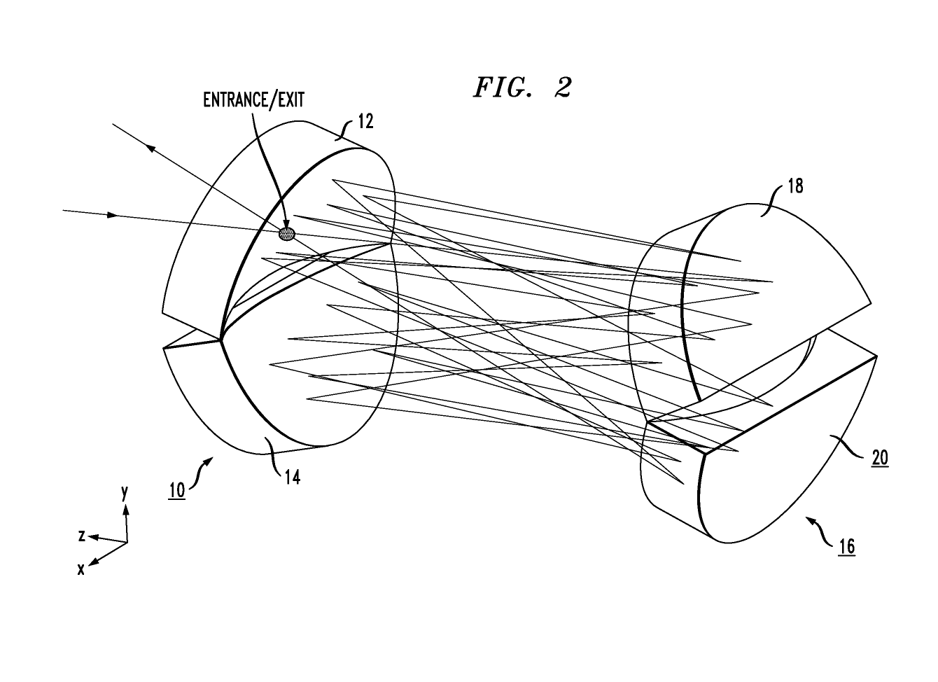

Referring to FIG. 1, the configuration of the present invention comprises a first mirror pair 10 comprising split sections 12 and 14, and a second mirror pair 16, comprising split sections 18 and 20. Each section is shown as angled at a tilt angle of θ with the y-axis, that is, with each section tilted inward toward the optical axis OA. For the purposes of illustration, this tilt angle is exaggerated. An exemplary angle for use in the arrangement of the present invention is approximately 0.016° (tilt angles less than about 1.0° are considered preferable). Although each mirror section is shown as comprising essentially the same tilt angle, it is possible to utilize a configuration where each section is oriented at a different angle. FIG. 2 is an isometric view of mirror pairs 10, 16 of FIG. 1, showing the path of an incoming ray as it bounces off of the split minor configuration.

Spot patterns that overlap beam spots with the mirror gap cut area can be ignored, and the spot pattern can be optionally made to be reentrant to enter and exit the cell through the same hole and provide alignment stability. Rectangular mirrors are preferred because the spot pattern usually fills in a rectangular pattern on the mirror, which would waste the unused mirror area and increase cell volume on a circular mirror. The following definitions can be used:

$$( \begin{matrix}1 & d \\ 0 & 1\end{matrix} )$$

ABCD matrix for free space, where d is the spacing between minors along the optical axis;

$$( \begin{matrix}1 & 0 \\ - \frac{2}{R} & 1\end{matrix} )$$

ABCD matrix for curved reflection (mirror), where R is the radius of curvature for the mirror;

$$\frac{1}{q} = \frac{1}{R} - \frac{i λ}{π {W}^{2}}$$

complex beam parameter, with λ being the operating wavelength, w the beamwaist; and

$${q}_{2} = \frac{{Aq}_{1} + B}{{Cq}_{1} + D}$$

ABCD matrix transformed complex beam parameter.

The various ABCD matrix expressions are combined in a sequence to trace the beam through the multipass cell.

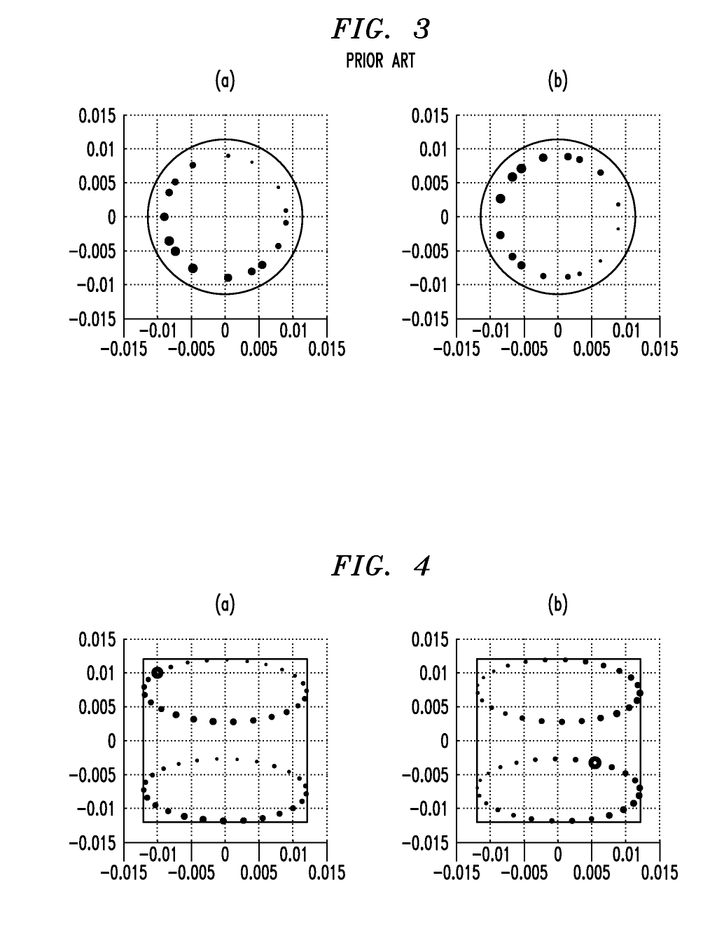

The spot pattern for a prior art circular mirror is shown in FIG. 3 and was simulated in MATLAB using ABCD matrices with tracking of the q complex beam parameter over the path. The pattern shown in FIG. 3(a) is associated with the “left hand” mirror and the pattern shown in FIG. 3(b) is associated with the “right hand” mirror. Each minor bounce uses the standard ABCD matrix for spherical mirrors, but when the mirror is tilted in accordance with the present invention, the effective entrance angle to the optical element is changed to compensate.

For the split mirror configuration of the present invention as shown in FIGS. 1 and 2, the simulation software determines which half of the y-plane the spot should hit to determine the corresponding tilt of the mirror. The top half of the y-plane (associated with, for example, mirror sections 12 and 18) requires a tilt in one direction and the bottom half (mirror sections 14 and 20) requires a tilt in the opposite direction. The software then adjusts the y entrance angle according to the specified tilt. The x axis ray-tracing and complex beam parameter tracking of the bounces is taken as independent of the y-axis. FIG. 4 illustrates the spot pattern associated with the split mirror configuration of the present invention (FIG. 4(a) for first mirror pair 10 and FIG. 4(b) for second mirror pair 16). In this case, the pattern was created for a tilt angle of 0.6° (the same tilt for each mirror section), with a separation d between split mirrors of 0.175 m, using 100 beam passes to create the pattern. The two complex beam parameters can be used to determine the shapes of the beam as an oval to a first order approximation. However, for these simulations, the spot size was simply taken as the larger between the x and y spot sizes to increase simulation speed.

To calculate the appropriate distance of the mirrors d to achieve a re-entrant pattern for N (integer) passes with M (integer) winding number (related to number of orbits before returning to either the entrance coordinate or at the symmetric point through the origin) the following analysis is used:

$$define {θ}_{x} = π \frac{{M}_{x}}{N} , {θ}_{y} = π \frac{{M}_{y}}{N} and d = 2 f ( 1 - cos θ ) ,$$

then assure that d's match when substituting θₓ and θ_{y} for θ.

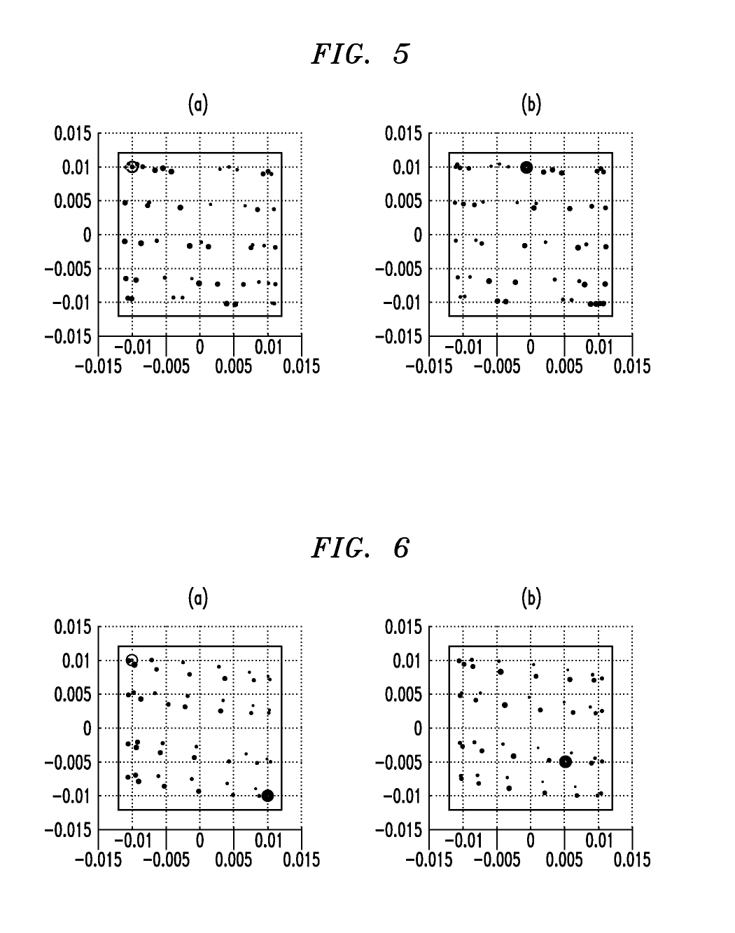

To find good spot patterns with maximum spot spacing, patterns with exit and entrance through the same hole, and patterns that do not exceed a certain clear aperture of the mirrors, iterations through various configurations can be performed, selecting the best configuration based on a desired parameter (usually the largest spot spacing). The angles of beam entry are continuously varied, along with the winding number Mₓ. For each of these entry angle and winding number configurations, the angle of tilting of the mirrors can be varied to find a configuration which satisfies the necessary constraints. FIGS. 5 and 6 illustrate exemplary spot patterns showing Lissajous-like patterns for both first mirror pair 10 (FIGS. 5(a), 6(a)) and second mirror pair 16 (FIGS. 5(b), 6(b)). For the embodiment associated with beam patterns of FIG. 5, a tilt angle of 0.6° was used, with a separation d of 0.104 m.

The cell entrance and exit angles for re-entrant cells exactly mirror each other, but it is slightly more complicated to achieve a reentrant pattern with the type of cell specified in the invention. This is because the spots may not be distributed evenly among the four half mirrors, and the pattern is not a true Lissajous pattern. However, the simulations can determine how closely the actual exit angle deviates from the desired re-entrant exit, and choose the best configurations. The method to achieve exact M_{y} which may allow relatively exact re-entrant conditions involves determining the circle of least confusion for the overall effective focal length for a given pair of tilted mirrors.

As mentioned above, the mirrors should generally be tilted at the same angle, but other configurations can be implemented with non-symmetric tilt (including the case of “no tilt”) for application specific implementations. Additionally, the mirror can be further split into more regions to improve the congruence to a true Lissajous pattern, at a cost of expense in manufacturing segments of mirrors and gap regions.

A non-symmetric method can also be used (i.e., with different focal lengths for each half mirror) to achieve different types of patterns. Additionally, the entrance hole can be taken at any location in the cell as long as the corresponding pattern does not overlap the gaps.

### Mirror Manufacturing

To additionally produce mirrors of low cost, the present invention discloses a method to produce the split mirror configurations at low cost with minimal waste material. In normal spherical mirror production, the mirrors are ground to λ/4 to λ/10 precision at λ=visible wavelengths, which can provide the least scattering. ‘D’ shaped flat mirrors are generally available as commercial products, since the substrate can be easily cut from a single bulk material. In producing a half spherical mirror, there is a possibility for waste material if the mirror was split in half by cutting, since spherical mirrors are ground as a single unit. Additionally, if the two halves were ground separately, there is more chance for focal length error between the two half mirrors.

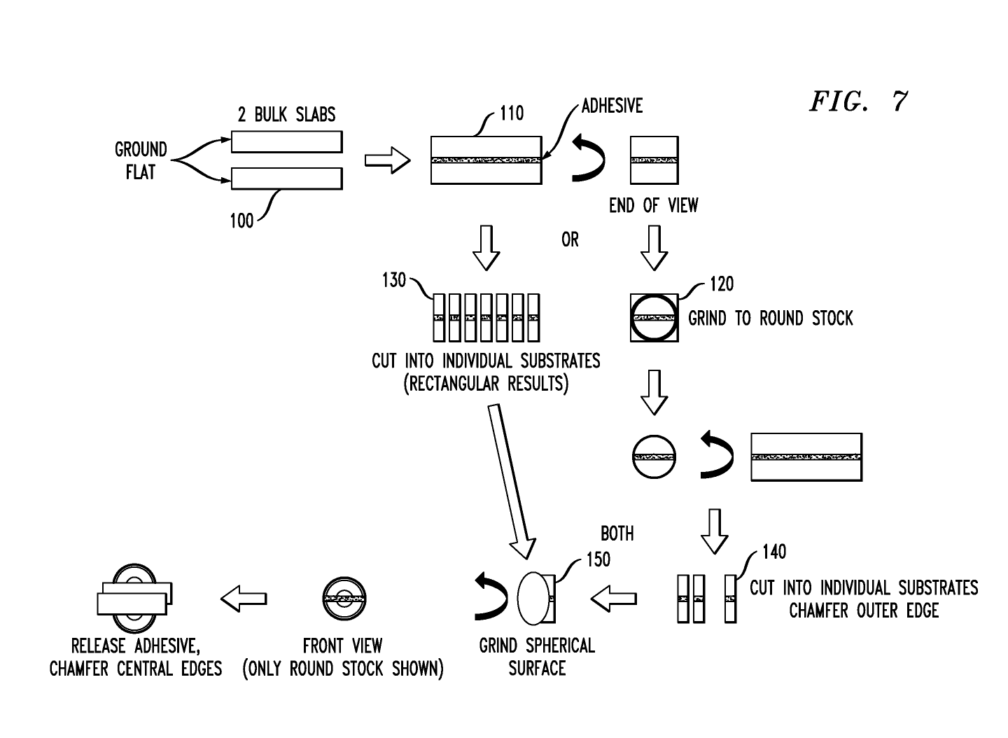

The inventive method to improve the manufacturability of half concave mirrors is shown by the processing sequence in FIG. 7. As shown, the process begins at step 100 by having two slabs of material to be ground relatively flat on two sides. The two slabs of material are either clamped together or an adhesive can hold the two flat sides in contact (step 110). The combined single slab stock can then be machined into either a cylinder for round half mirrors (step 120), or rectangular (perpendicular with the flat surface). The stock can then be cut into blank substrates (steps 130 or 140), and ground to a spherical surface (step 150). Then the clamps or adhesives is then removed to release the two halves (step 160), forming a pair of concave mirrors with essentially the same characteristics (focal length, surface quality, etc.). The two halves of a spherical surface can then be coated with optical coatings (metal, dielectric, etc) and further processed as desired.

The advantage of this process include the following: 1) the resulting half mirrors have the same focal length; 2) fit together exactly to minimize gap area; 3) minimize waste material; 4) can produce rounded “D” shaped mirrors which have focal centers relatively aligned; and 5) double the speed of grinding the concave surfaces, since the two halves are created at once.

### Mounting Methods for the Mirrors

This aspect of the invention describes four methods of mounting the mirror pairs of the multipass cell to achieve a tilted alignment of the mirror halves. The methods fit into two categories: cage type, and non-cage type. In the cage type mounts, the mirrors are affixed to the mirror mounts, which in turn are fixed in position by a cage-like envelope of a number of supporting bars that run parallel to each other along the physical length of the multipass cell.

The following methodologies will only describe one side of the multipass cell, as the other side is symmetric and thus the same in each case. Further, affixing the mirrors to the mirror mounts can be achieved multiple ways. The simplest solution is gluing, but this voids the possibility of future adjustments. Alternatively, with added complexity, the mirrors may be clamped, enabling future adjustment of mirror orientation and position.

Method 1—cage type—Each mirror half is affixed to a separate mirror mount. To achieve the angled orientation of the mirrors, and thus of the mirror mounts, angled mounting holes for the cage rods are drilled into the mirror mounts. As the cage bars all run parallel to each other, the angled holes on the mirror mounts orient the affixed mirror halves in a tilted position.

Method 2—cage type—For this method, as opposed to Method 1, each pair of mirror halves share a single mirror mount and the cage bar mounting holes are not at an angle. Instead, two oppositely angled, symmetric semi-circle mounting features are bored into the mirror mount. The mirror halves are then affixed, and are effectively angled.

Method 3—cage type—This cage type method is similar to Method 2 in that each pair of mirror halves share a single mirror mount. Dowel pins locate the mirror edge surface, and gauge pins are used to set the mirror angle.

Method 4—non cage type—In this non-cage type method, the structural support normally provided by the cage bars in cage-type designs is replaced by either a cylindrical tube or a rectangular tube bored through along its length. At each end of this structural tube, mirror half mounting features as described in Method 2 are bored into the structure. The mirror halves are then affixed, and are effectively angled. This creates a sealed-path multipass cell. If required, holes can be drilled, or slots can be milled or sawed into the structural tube to achieve an open path configuration.

### Beam Entry/Exit

The beam can enter and exit in various different ways from this type of multipass cell. Either a steering mirror can be affixed at the entrance and/or exit point, or a hole can be drilled with steering performed outside of the cell. Additionally, notches can be ground into the edge of the mirrors instead of drilling into the mirror substrate. Another method is a masked area which is uncoated or removal of mirror coating in a certain area. The beam can then enter the cell by passing through this region of the substrate; however, the mirror substrate must be relatively optically transparent to avoid power loss.

In particular, the utilization of one of the following exemplary beam entry/exit configurations may be appropriate for use with the multipass cell of the present invention: (1) one hole per cell; (2) two holes per cell; (3) one or two notches per cell (on edge of mirror); (4) an uncoated spot on mirror as entry/exit; (5) an implanted/cemented mirror on minor as a beam entry/exit; or (6) a fiber-coupled collimator inserted into a hole or notch in the mirror.

While this disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essentials cope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. An optical multipass cell comprising:
a first split spherical mirror, each split portion tilted inward toward an optical axis of the multipass cell; and
a second split spherical mirror disposed in opposition to the first split spherical mirror along the optical axis and separated therefrom by a predetermined distance d, each split portion tilted inward toward the optical axis, wherein the tilt angles of the split portions and the separation distance d are configured to create a spot pattern of a desired density.

2. An optical multipass cell as defined in claim 1 wherein the first split spherical mirror is split into a pair of portions.

3. An optical multipass cell as defined in claim 1 wherein the second split spherical mirror is split into a pair of portions.

4. An optical multipass cell as defined in claim 1 wherein each split portion is tilted inward at essentially the same tilt angle.

5. An optical multipass cell as defined in claim 4 wherein the tilt angle is about 0.016°.

6. An optical multipass cell as defined in claim 1 wherein each split portion is tilted inward at a unique tilt angle.

7. An optical multipass cell as defined in claim 1 wherein the separation d is determined from d=2f(1−cos θ), where
$${θ}_{x} = π \frac{{M}_{x}}{N} , {θ}_{y} = π \frac{{M}_{y}}{N} , N$$
is the number of beam passes within the cell, M is the winding number and x and y are the coordinates orthogonal to the optical axis.
